(19) United States
(12) Patent Application Publication
(10) Pub. No.: US 2010/0326771 A1
(43) Pub. Date: Dec. 30, 2010

(54) PLATFORM UNIT HAVING LIFT-OFF PROTECTION AND METHOD FOR SECURING A PLATFORM UNIT AGAINST LIFT-OFF AND METHOD FOR RELEASING A PLATFORM UNIT SECURED AGAINST LIFT-OFF

(75) Inventor: Helmut Kreller, Bad Rappenau (DE)

Correspondence Address: COLLARD & ROE, P.C., 1077 NORTHERN BOULEVARD, ROSLYN, NY, 11576, US

(73) Assignee: Wilhelm Layher Verwaltungs-GmbH, Gueglingen-Eibensbach (DE)

(21) Appl. No.: 12/735,893

(22) PCT Filed: Dec. 17, 2008
(86) PCT No.: PCT/DE2008/002103

§ 371 Date: Aug. 24, 2010

(30) Foreign Application Priority Data
Mar. 19, 2008 (DE) 10 2008 015 066.5

(51) Int. Cl. E04G 1/15; G05G 1/04; E04G 7/00

(52) U.S. Cl. 182/222; 74/523

(57) ABSTRACT

A coating unit (20), comprising a lift-off protection (25) that is fastened in a face end region (21) of the coating unit (20) and is formed by a securing pivot lever (26), which can be manually pivoted about a pivot axis (27), which in the usage position (22) of the coating unit (20) is vertical, from an open position, in which the coating unit (20) can be placed onto a horizontal carrier (30) or lifted off therefrom, into a closed or lift-off protection position (31), and vice versa, in which the coating unit (20) is secured against lift-off from the carrier (30) when it is placed on the carrier (30). At least in the closed or lift-off protection position (31′) thereof, the securing pivot lever (26) is secured by a spring-elastic detent element (35) against accidental pivoting about the pivot axis (27) in an engagement position (29) such that pivoting of the securing pivot lever (26) about the pivot axis (27) from the closed or lift-off protection position (31) into the open position is only possible by applying an increased pivoting force. The invention also relates to a method for securing a coating unit (20) against lift-off from a carrier (30) and to a method for releasing a coating unit (20) that is secured against lift-off.

The invention relates to a platform unit, particularly a scaffold platform unit, preferably a scaffold floor, having at least one lift-off protection attached in a face end region of the platform unit, which is formed by a securing pivot lever, which can be pivoted manually, preferably without any tools, about a pivot axis that is preferably vertical in the usage position of the platform unit, particularly an axis of rotation, from an open position, in which the platform unit can be laid onto a horizontal carrier, particularly a cross-bar, preferably a transverse cross-bar, for example a scaffold pipe, or lifted off from it, into a closed or lift-off protection position, and vice versa, in which the platform unit, when it is laid onto the carrier, is secured against lift-off from the carrier.

The invention also relates to a method for securing a platform unit against lift-off from a carrier, according to claim 27, and to a method for releasing a platform unit that has been secured against lift-off from a carrier, according to claim 28.

Platform units are frequently used in the sector of scaffolding, staircases, podia, stages, or similar support constructions or spatial support structures. The platform units are usually laid onto horizontal carriers, particularly cross-bars, preferably transverse cross-bars, for example scaffold pipes, which are preferably round pipes or U profiles, or suspended there by means of suspension aids. The platform units must be secured against lift-out or lift-off, because unintentional lift-off, particularly caused by wind forces, can lead to severe accidents and injuries.

In the past, a plurality of the most varied ancillary constructions has been used to secure platform units. These include constructions in which securing elements that can be activated manually, preferably without any tools, can be pivoted, in the face end region of the platform units, about a pivot axis that is vertical in the usage position of the platform unit, from an open position, in which the platform unit can be lifted off or laid on, into a lift-off protection position, in which the securing elements engage underneath the horizontal carriers or scaffold pipes.

Such a construction has become known, for example, from DE 198 38 625 A1. There, a securing lever is clamped, using a securing tab that surrounds it, on the vertical face side of a scaffold floor, between the securing tab and the vertical face side of the scaffold floor, manually, preferably without any tools, so as to rotate. The securing lever is angled away both at its upper end and at its lower end, in approximately the same directions. In the lift-off protection position, both the angled-away upper end of the securing lever and the angled-away lower end of the securing lever engage over the scaffold pipe. In this manner, lift-off protection is therefore implemented.

Another construction by the patent proprietor itself has become known from practice. In this connection, a thin, elongated sheet-metal strip is riveted in place on a horizontal wall of a face end profile, which is configured as a transverse cap, which wall is the lower wall in the usage position of a scaffold floor. The sheet-metal strip can be rotated manually, preferably without any tools, by 360 degrees, about the vertical axis of rotation imparted by the rivet, so that the sheet-metal strip, can, among other things, be rotated into an open position, in which the scaffold floor, which is provided with suspension hooks, can be lifted off from a scaffold pipe or laid on or suspended on there, and can be pivoted into a lift-off protection position, in which the sheet-metal strip engages underneath the scaffold pipe when the scaffold floor is lying on or suspended on it, so that the scaffold floor is then secured against lift-off.

Both constructions have the common disadvantage that the securing lever, at least at the beginning, is difficult to rotate, and that this can be done only using a tool, for example a hammer, if necessary. During the course of use, in other words after repeated activation of the safety lever, over time loosening of the tightness of the safety lever, in each instance, all to the way to free rotatability of the same can occur, thereby making it possible to manually rotate the securing lever, in each instance, easily, without using any tool, but then, unintentional release of the safety lever, i.e. unintentional pivoting of the lever from the lift-off protection position into a lift-off position or open position can occur, so that the scaffold floor is then no longer secured against lift-off. This represents a significant safety risk. Furthermore, in the case of both constructions, during installation and removal of the scaffold floor, hindrances resulting from the fact that the securing lever has become too easy to rotate, over time, can occur.

It is therefore a task of the invention to make available a platform unit with lift-off protection or a lift-off protection of a platform unit, with which the above disadvantages are avoided. In particular, it is a task of the invention to make available a platform unit with a lift-off securing pivot lever, which offers the possibility that right from the start, it can easily be pivoted manually over the entire period of use, i.e. at any time, but nevertheless is secured against unintentional pivoting about its pivot axis, at least in the closed or lift-off protection position.

This task is accomplished by means of a platform unit having the characteristics of claim 1, particularly in that the securing pivot lever, at least in its closed or lift-off protection position, is secured against unintentional pivoting about the pivot axis, in a first engagement position, by means of a spring-elastic detent element, preferably with the formation of a shape-fit engagement, in such a manner that pivoting of the securing pivot lever about the pivot axis, from the closed or lift-off protection position into the open position, is only possible when an increased pivoting force is applied.

By means of providing such a spring-elastic detent element, by means of which a preferably shape-fit engagement in a securing engagement position is possible, it is possible to achieve a securing engagement position that is reliable and reproducible at all times, and a possibility for otherwise essentially free rotatability of the securing pivot lever about its pivot axis, from the beginning, i.e. at all times. By means of the use of such a spring-elastic detent element, it is possible to achieve audible engagement in an engagement position, so that in this way, it can be additionally signaled to the user that the lift-off protection is in the desired position, i.e. here, the closed or lift-off protection position.

According to a preferred embodiment, it can additionally be provided that the securing pivot lever, even in its open position, is secured against unintentional pivoting about the pivot axis, in a second engagement position, by means of a or of the spring-elastic detent element, preferably with the formation of a shape-fit engagement, in such a manner that pivoting of the securing pivot lever about the pivot axis, from the open position into the closed or lift-off protection position, is only possible when an increased pivot force is applied. In this manner, it is also possible to achieve releasable locking, by means of the or an additional spring-elastic detent element, in at least one or the open engagement position, with the position being clearly defined right from the start, i.e. at all times. There, as well, it can be additionally signaled to the user, by means of an audible engagement, that the lift-off protection is in the desired position, now in an or the open position.

In a preferred embodiment, it can be provided that the securing pivot lever carries the detent element attached or mounted on or in it. In this manner, the detent element can therefore also be pivoted about the pivot axis when the securing pivot lever is pivoted about its pivot axis. It is understood, however, that the detent element can also be provided on or in a separate part, particularly a part provided in the face end region of the platform unit, preferably a face end profile of the platform unit, or even on or in the carrier itself.

According to a particularly preferred embodiment, it can be provided that the securing pivot lever has a first lever arm that extends transverse, preferably perpendicular, from the pivot axis, in a first direction, and a second lever arm that extends away transverse, preferably perpendicular, in a second direction, particularly in an opposite direction, and that the at least one detent element is attached or mounted either in or on the second lever arm, preferably in the region of its free end, or that the at least one detent element resiliently engages on the second lever arm. In this manner, advantageous lever arm conditions and, accordingly, pivot forces can be achieved, for the purpose of unsecuring or unlocking the resilient detent element.

It can be particularly advantageous if the or every securing pivot lever has a single detent element assigned to it, or if the or every securing pivot lever contains a single resilient detent element.

According to a particularly preferred embodiment variant, it can be provided that the single detent element allows both engagement of the securing pivot lever in a securing engagement position, in which it is secured against pivoting about its pivot axis, from its closed or lift-off protection position, into a or the open position, and also allows engagement of the securing pivot lever in an open engagement position, in which the securing pivot lever is secured against pivoting about its pivot axis, from the open position into a or the closed or lift-off protection position. By means of integration of these functions, it is possible to achieve a particularly cost-advantageous and robust construction.

Furthermore, according to another preferred embodiment, it can be provided that the detent element is engaged, with shape fit, in the one or in the engagement position, in each instance, in an opening, particularly in a hole or in a bore, preferably of a part provided in the face end region of the platform unit, particularly a face end profile of the platform unit. Such a construction can be implemented in particularly simple and cost-advantageous manner.

In a particularly preferred further development, it can be provided that at least one first opening for engagement of the resilient detent element in a or in the securing engagement position of the securing pivot lever and at least one second opening for engagement of one or of the resilient detent element in an or the open engagement position of the securing pivot lever is provided, in a part provided in the face end region of the platform unit, preferably a face end profile of the platform unit, whereby the openings are disposed at a distance from the pivot axis, in each instance, and at a distance from one another, and offset by a circumference angle, relative to one another, relative to the pivot axis. In accordance with this predetermined or predeterminable circumference angle, defined angle positions of the securing engagement position(s) and the open engagement position(s) of the securing pivot lever can therefore then be implemented.

In a particular further development, it can be provided that the circumference angle amounts to about 90 degrees. Accordingly, a securing engagement position and an open engagement position for the securing pivot lever can be defined, which signals the end position, in each instance, in a manner that is clear to the user, i.e. whether the securing pivot lever is in a closed or lift-off protection position or in an open position.

According to another advantageous embodiment, it can be provided that the or every opening is configured as an oblong hole, in each instance, whose longitudinal axis extends transverse, preferably perpendicular to the pivot axis of the securing pivot lever, preferably intersects the pivot axis. In this way, advantageous production conditions as well as advantageous release conditions can be achieved, at comparatively tightly defined or tolerated engagement angle positions for the securing engagement position and for the open engagement position.

According to a particularly preferred embodiment, it can be provided that the resilient detent element is formed by a pressure piece acted on by means of a spring, particularly a pressure spring, preferably in the form of a pin or a ball, or that the resilient detent element is a pressure piece acted on by means of a pressure spring, preferably in the form of a pin, particularly in the form of a ball. Such a detent element can be made available in particularly simple and cost-advantageous manner, and allows reliable functioning of the lift-off protection device over a long period of time.

In a concrete advantageous further development, it can be provided that the spring and the pressure piece are accommodated in a cavity of a hollow body that has an overlap part that secures the pressure piece against falling out, which piece overlaps over the cavity, whereby the pressure piece rests against the overlap part, acted on by the spring force, with the formation of pressure forces, when the securing pivot lever is situated in one of its engagement positions, i.e. particularly in the securing engagement position and/or in the open engagement position.

However, it is understood that the pressure piece does not necessarily have to lie against the overlap part in these engagement positions, but rather that the pressure piece must be sufficiently engaged or locked in the engagement position, in each instance.

According to an advantageous further development, it can be provided that the hollow body that contains the spring and the pressure piece is attached in, preferably pressed into an opening or bore, particularly of the securing pivot lever. This allows particularly cost-advantageous production in combination with production within particularly reproducible, close production tolerances.

Furthermore, it can be advantageous if the securing pivot lever is attached on a part provided in the face end region of the platform unit, preferably a face end profile, using an attachment medium that contains the pivot axis.

Particularly cost-advantageous production can be achieved in that a rivet is used as an attachment medium. Such a rivet can be connected with the part of the platform unit that is preferably configured as a face end profile, particularly and preferably essentially so as to rotate freely, in other words in non-jamming manner. In this way, particularly easy movement during pivoting of the securing pivot lever about its pivot axis can be achieved right from the beginning, i.e. at all times. The easy movement can be further improved in that a washer, preferably made of plastic, particularly of polyamide, is disposed between the securing pivot lever and the part to which the securing pivot lever is attached. The bore of this washer then has the pivot axis of the securing pivot lever passing through it in the assembled state.

It is particularly advantageous if the securing pivot lever is attached and/or mounted on a wall of the part provided in the face end region of the platform unit, which wall is horizontal in the usage position of the platform unit, preferably a face end profile of the platform unit. However, it is understood that the securing pivot lever can also be attached and/or mounted on a side or face wall of the part provided in the face end region of the platform unit, for example, which wall is vertical in the usage position of the platform unit, preferably a face end profile of the platform unit.

In a preferred embodiment, it can be provided that the part or the face end profile is a transverse cap made of metal, preferably of zinc-plated steel sheet. This allows not only a cost-advantageous and particularly robust overall construction of a platform unit, but also allows secure, firm attachment and/or mounting of the securing pivot lever.

For the purpose of an even clearer determination of the limits or positions of the closed or lift-off protection position, on the one hand, and of the open position of the pivot lever, on the other hand, it can be provided that the securing pivot lever has at least one first stop, preferably extending transverse to its longitudinal axis and parallel to the pivot axis, particularly extending in the vertical direction in the usage position of the vertical unit, which stop prevents further pivoting of the securing pivot lever in the first pivot direction, beyond the closed or lift-off protection position, into another open position, when the securing pivot lever is rotated about its pivot axis in a first pivot direction, from an or the open position, into the closed or lift-off protection position, particularly by means of making contact on a or the part provided in the face end region of the platform unit, preferably a face end profile of the platform unit, preferably by means of making contact on a vertical face transverse wall of the part provided in the face end region of the platform unit, which wall is in front in the usage position of the platform unit, preferably a face end profile of the platform unit.

In addition or alternatively, it can be provided that the securing pivot lever has a second stop, if applicable, preferably extending transverse to its longitudinal axis and parallel to the pivot axis, particularly extending in the vertical direction in the usage position of the platform unit, which stop prevents further pivoting of the securing pivot lever in this second pivot direction, if applicable, from the closed or lift-off protection position into an or the open position, when the securing pivot lever is rotated about its pivot axis in a second pivot direction, if applicable, from the closed or lift-off protection position into an or the open position, particularly by means of making contact on a or the part provided in the face end region of the platform unit, preferably a face end profile of the platform unit, preferably by means of making contact on a vertical face transverse wall of a or the part provided in the face end region of the platform unit, which wall is in front in the usage position of the platform unit, preferably a face end profile of the platform unit.

In a particularly advantageous embodiment, it can be provided that the first stop and the second stop are part of a common stop of the securing pivot lever, so that both end stop positions can therefore be implemented with a single stop body. The first stop and the second stop, if applicable the common stop body, can preferably be configured in the form of a projection.

It is particularly advantageous if the first stop and the second stop, preferably the common stop body, is/are disposed on the securing pivot lever in such a manner, and if the securing pivot lever is disposed, attached and/or mounted on a part, preferably the face end profile of the platform unit, in such a manner that the securing pivot lever can be pivoted about a pivot angle of maximally 180 degrees, particularly of maximally 100 degrees, preferably of maximally about 90 degrees, about its pivot axis.

A particularly robust and stable construction of a securing pivot lever, with which even high loads, particularly high wind loads, can be reliably absorbed, can be achieved in that the securing pivot lever consists essentially of cast metal, particularly of zinc die-casting, tempered or steel casting.

The securing pivot lever can be painted or powder-coated in a signal color. In this manner, the status (open/closed) of the floor securing mechanism is already visible at a distance.

In a preferred construction of a platform unit, it can be provided that this unit, at least in the region of a face end region, preferably on a part provided there, particularly a face end profile of the platform unit, has suspension aids that project beyond the face end region, preferably suspension hooks, for laying the platform unit onto or suspending the platform unit on a horizontal carrier, particularly a cross-bar, preferably a transverse cross-bar, for example a scaffold pipe, and that the securing pivot lever attached and/or mounted in the face end region, preferably on a part, particularly on a face end profile of the platform unit, engages underneath the carrier when the platform unit is laid onto the carrier by way of its suspension aids or suspended on it. In this manner, the carrier is secured or braced, in the lift-off protection position, between the suspension aids, on the one hand, and the securing pivot lever, on the other hand, against lift-off of the platform unit from the carrier.

It is particularly advantageous if the platform unit, in the region of two of its face end regions that extend away from one another in opposite directions, preferably on parts provided there, in each instance, particularly face end profiles of the platform unit, has suspension aids that project beyond these face end regions, preferably suspension hooks, for laying the platform unit onto or suspending the platform unit on two horizontal carriers, particularly cross-bars, preferably transverse cross-bars, for example scaffold pipes, and that the platform unit is equipped with at least two such securing pivot levers, of which a first securing pivot lever is attached and/or mounted in a first face end region, preferably on a first face end profile provided there, and of which a second securing pivot lever is attached and/or mounted in a second face end region, preferably on a second face end profile provided there, whereby each securing pivot lever engages underneath the horizontal carrier in its closed or lift-off protection position, when the platform unit is laid onto the carrier or suspended on it, by way of its suspension aids.

The invention furthermore relates to a scaffold, podium, staircase, stage, or similar support construction or spatial support structure, having at least two horizontal carriers, particularly cross-bars, preferably transverse cross-bars, for example scaffold pipes, on which a platform unit according to at least one of claims 1 to 25 is laid or suspended, which has at least one such securing pivot lever, in each instance, on two of its face end regions that extend away from one another, in opposite directions, preferably on parts provided there, in each instance, particularly face end profiles of the platform unit.

The invention also relates to a method for securing a platform unit, particularly a scaffold platform unit, preferably a scaffold floor, against lift-off from a horizontal carrier, particularly a cross-bar, preferably a transverse cross-bar, for example a scaffold pipe, where a platform unit, particularly one configured according to at least one of claims 1 to 25, using a lift-off protection formed by a securing pivot lever, by means of manual pivoting, preferably without any tools, of the securing pivot lever, about a pivot axis that is preferably vertical in the usage position of the platform unit, particularly an axis of rotation, from an open position, in which the platform unit can be laid onto the horizontal carrier or lifted off from it, after the platform unit has been laid onto or suspended on the carrier, into a closed or lift-off protection position, and also into a securing engagement position, in which, during the course of manual pivoting of the securing pivot lever about its pivot axis, a spring-elastic detent element brings about shape-fit engagement of the securing pivot lever, preferably on a part that carries it, particularly a face end profile of the platform unit, so that then, the securing pivot lever can be pivoted out of its closed or lift-off protection position into the open position only when an increased pivot force is applied.

The invention also relates to a method for releasing a platform unit, particularly one configured according to at least one of claims 1 to 25, particularly a scaffold platform unit, preferably a scaffold floor, which has been secured against lift-off from a horizontal carrier, particularly a cross-bar, preferably a transverse cross-bar, for example a scaffold pipe, using a lift-off protection that is formed using a securing pivot lever, whereby the securing pivot lever, proceeding from a closed or lift-off protection position, in which the platform unit is secured against lift-off from the carrier, with the formation of a shape-fit engagement of the securing pivot lever, brought about by means of a spring-elastic detent element, preferably on the part that carries it, particularly a face end profile of the platform unit, in a securing engagement position, the securing pivot lever is pivoted manually, preferably without any tools, with the application of an increased pivoting force and with simultaneous unlocking or unblocking of the resilient detent element, from the closed or lift-off protection position into an open position, in which the platform unit can be lifted off from the carrier.

In an advantageous embodiment of this method, it can be provided that in the course of the manual pivoting of the securing pivot lever about its pivot axis, from the closed or lift-off protection position into the open position, then a spring-elastic detent element or the spring-elastic detent element brings about a shape-fit engagement of the securing pivot lever, preferably on a part that carries it, particularly a face end profile of the platform unit, in an open engagement position, so that then, the securing pivot lever can be pivoted out of this open position or pivoted out only when an increased pivoting force is exerted.

Additional advantages, characteristics, and aspects of the invention are evident from the following description part, in which a preferred exemplary embodiment of the invention is described using the figures.

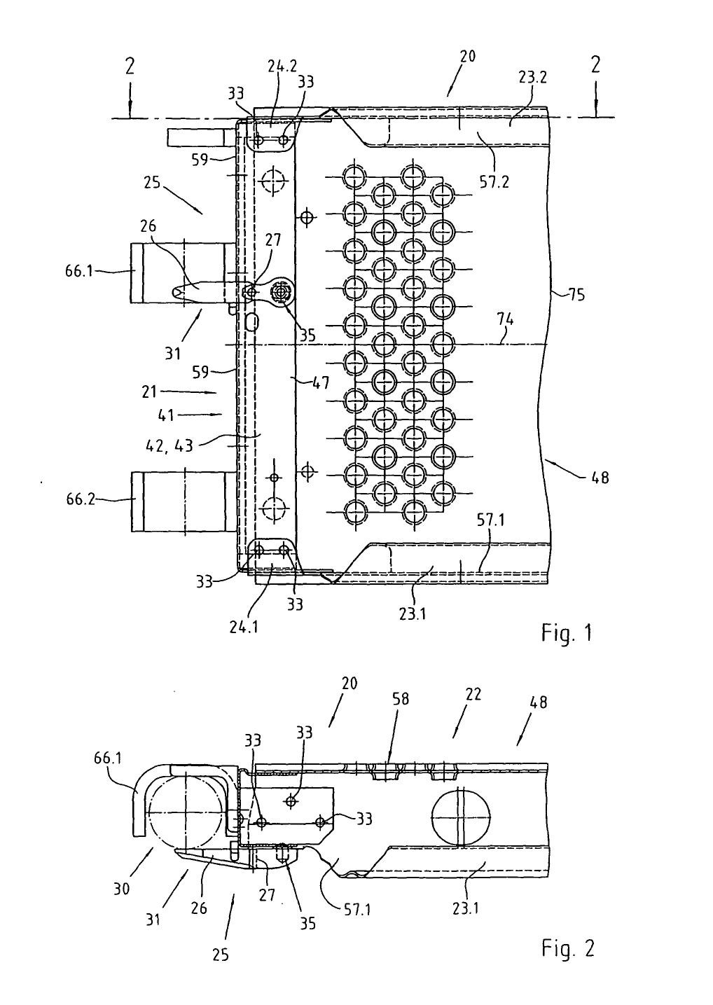

FIG. 1: A bottom view of a detail of a platform unit according to the invention, in the region of one of its face end regions, with a lift-off protection according to the invention, configured with a securing pivot lever attached to a transverse reinforcement profile;

FIG. 2: a longitudinal section of the platform unit along the section lines 2-2 in FIG. 1;

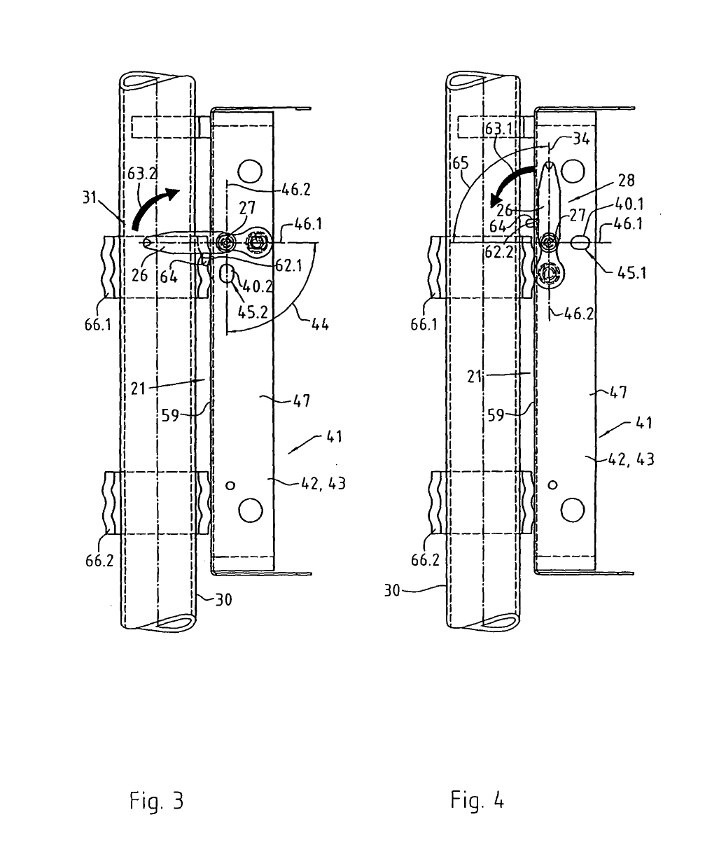

FIG. 3: a bottom view, on a larger scale, of parts on the face end side of the platform unit according to FIG. 1, provided with suspension hooks, with the securing pivot lever in a closed or lift-off protection position, in which the platform unit is secured against lift-off from a carrier;

FIG. 4: a representation that corresponds to FIG. 3, whereby the securing pivot lever is now in an open position, pivoted by about 90 degrees as compared with the closed or lift-off protection position, here in the clockwise direction, in which the platform unit can be lifted off from the carrier;

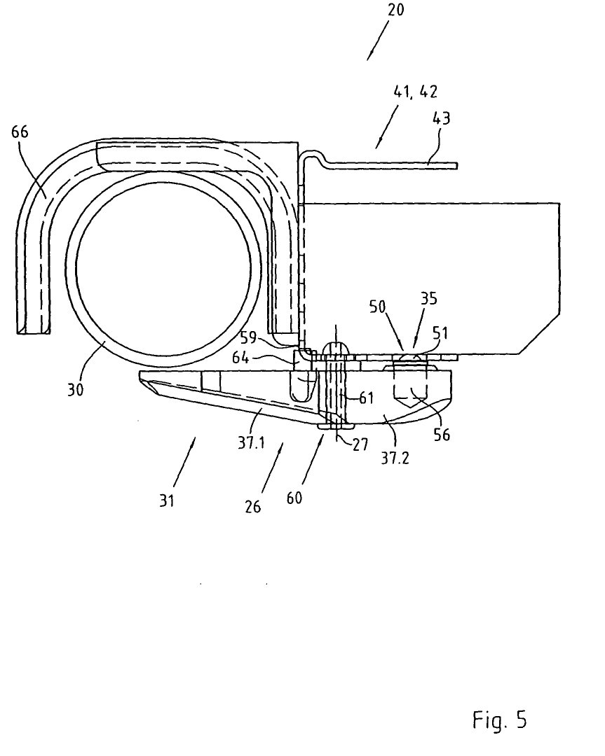

FIG. 5: a greatly enlarged side view of parts of the platform unit on the face end side, according to FIG. 2, to illustrate details of the securing pivot lever, which is in its closed or lift-off protection position;

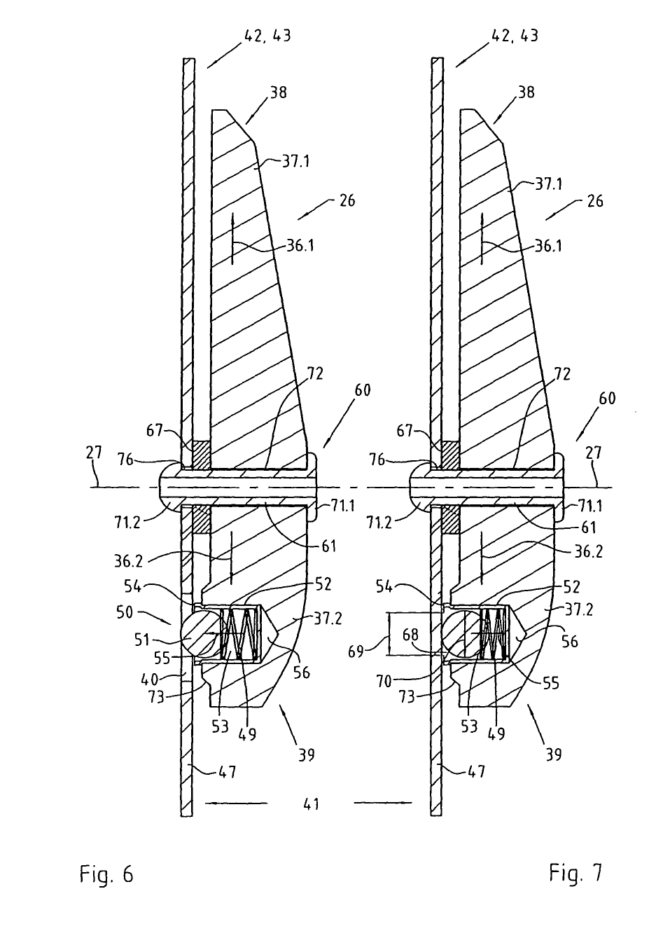

FIG. 6: a longitudinal section along the longitudinal axis of the securing pivot lever attached to the transverse reinforcement profile of the platform unit, in an engagement position, in which a spring-elastic engagement medium that is attached to the securing pivot lever and carried by it is engaged, with its spring-activated pressure piece, with shape fit, in a passage hole made in the transverse reinforcement profile, releasable again only by means of increased pivot forces;

FIG. 7: a longitudinal section of the securing pivot lever corresponding to the representation in FIG. 6, which, however, now is pivoted into an intermediate position, in which the spring-elastic engagement medium, and consequently the securing pivot lever, is not engaged against pivoting about its pivot axis, in other words can essentially be freely rotated about its pivot axis;

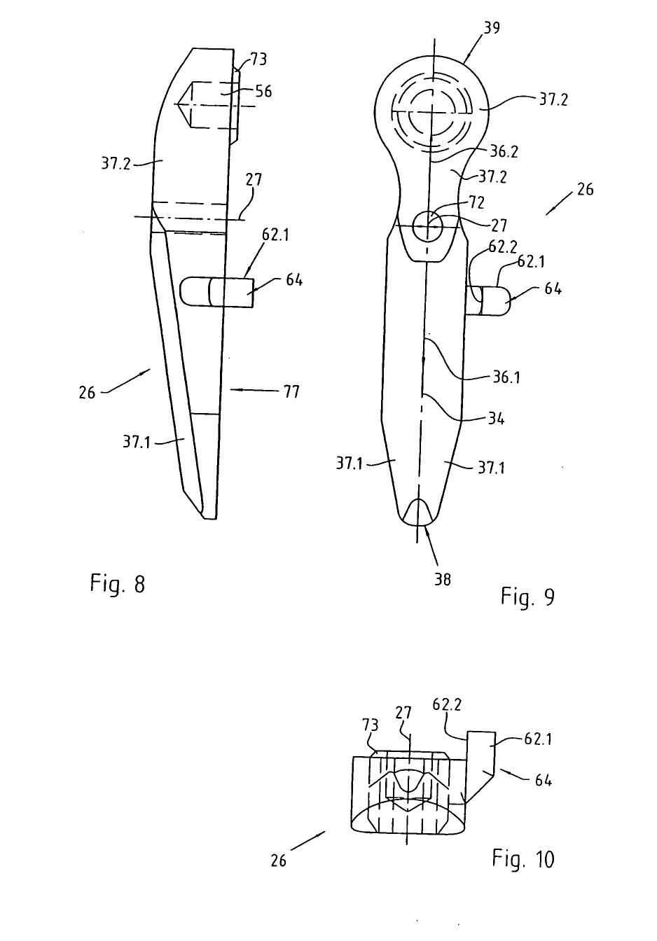

FIG. 8: a greatly enlarged side view of the securing pivot lever according to FIG. 9, from the right;

FIG. 9: a top view of the securing pivot lever;

FIG. 10: a view of the securing pivot lever according to FIG. 8 from above.

The platform unit 20 particularly shown in FIGS. 1 and 2 is a catwalk or a scaffold floor 20. A detail of this is shown in the region of one of its two narrow longitudinal face sides. The scaffold floor 20 is configured symmetrically, if applicable with the exception of ancillary constructions and suspension aids 66 provided on the face side, which here are suspension hooks 66.1, 66.2, relative to its longitudinal center axis 74 and also symmetrically relative to its transverse center axis, which is configured perpendicular to the former, and is not shown in the figures.

Aside from the lift-off protection 25 and parts assigned to it, the platform unit as well as the suspension aids can be configured, in particular, as in DE 198 58 969 A1 or the parallel EP 1 010 838 A1, or also as in DE 198 58 970 A1 or the parallel EP 1 010 837 A1, but also as in DE 102 54 033 A1 or the parallel EP 1 426 523 A1, whose contents are incorporated in their entirety at this point, for the sake of simplicity.

The platform unit or the scaffold floor 20 comprises a floor profile part 48 produced from sheet steel, preferably using the rolling-bending method. The floor profile part 48 has a longitudinal edge bar 23.1, 23.2 at its two longitudinal sides, in each instance, which is/are connected or configured in one piece with the catwalk sheet metal 75 that has the walking and working surface 58. At the two longitudinal face sides of the floor profile part 48, the latter has a transverse reinforcement profile 42, also called a face end profile, in the form of a transverse cap or a transverse connection cap 43 inserted into it. Its connection shanks are firmly connected with the catwalk sheet metal 75, which is horizontal in the usage position 22 of the platform unit 20, with the side walls 57.1, 57.2 of the longitudinal edge bars 23.1, 23.2, which are vertical in the usage position 22, and with separate tabs 24.1, 24.2 provided on the face side, by way of local joining locations or connection structures 33, in each instance. The latter can be produced, in a concrete embodiment, by means of electrical resistance welding or spot welding.

Two suspension hooks 66.1, 66.2 are welded on, in each instance, on the face transverse wall 59 of the transverse reinforcement cap 43 that is vertical in the usage position 22 of the platform unit 20. These hooks are configured, here, optimized for being suspended on a horizontal round pipe or scaffold pipe 30 of a scaffold, also referred to as a carrier. However, it is understood that the suspension hooks can also be configured optimized for being suspended on or in horizontal cross-bars, which can be configured, in each instance, as a U profile open toward the top, with two lateral vertical shanks. It is furthermore understood that the horizontal carriers can also be configured with cross-sections other than those in a round shape or the shape of a U profile, and/or that suspension aids having a different configuration can be used. Thus, it is also possible that recesses or passage holes made in the face ends of the platform unit can be provided as suspension aids, so that the platform unit can be attached, preferably set onto accommodation elements in the form of a journal or pin, which can be attached to a carrier, cross-bar, scaffold pipe, or the like, projecting vertically upward.

According to the invention, it is provided that the platform unit 20 is provided with at least one lift-off protection 25 attached in its face end region 21, which is formed by a securing pivot lever 26, which can be pivoted manually, preferably without any tools, about a pivot axis 27 that is vertical in the usage position 22 of the platform unit 20, which here is a vertical axis of rotation 27, from an open position 28 (FIG. 4), in which the platform unit 20 can be laid onto a horizontal carrier 30, particularly a cross-bar, preferably a transverse cross-bar, for example a scaffold pipe 30, or lifted off from it, into a closed or lift-off protection position 31 (FIGS. 1, 2, and 3), and vice versa, in which the platform unit 20, when it is laid onto the carrier 30 (FIGS. 2 and 3), is secured against lift-off from the carrier 30.

In the concrete exemplary embodiment according to the invention, the securing pivot lever 26 is attached and mounted on a lower wall 47 of the transverse connection cap 43 that functions as a transverse reinforcement profile 42, by way of an attachment medium 60, here in the form of a rivet or hollow rivet 61 (cf. FIGS. 5 to 7), which wall is horizontal in the usage position 22 of the platform unit 20. For this purpose, a passage hole 76 is provided in the lower wall 47, through which hole the rivet 61 is inserted. The rivet 61 that contains the pivot axis 27 of the securing pivot lever 26, or the pivot axis 27, is/are disposed eccentrically, offset relative to the longitudinal center axis 74 of the platform unit 20. This allows advantageous stacking conditions of platform units that are of the same type or similar, and are to be stacked on top of one another. The securing pivot lever 26 has a bore 72, through which the rivet 61 is inserted in the assembled state. In order to facilitate pivoting of the securing pivot lever 26 about its pivot axis 27, a washer 67 is disposed between the securing pivot lever 26 and the lower wall 47. This can preferably consist of plastic, particularly of polyamide. The washer 67 has a passage bore through which the rivet 61 is also inserted. The rivet 61 has two rivet heads 71.1 and 71.2. The first rivet head 71.1 is configured flat here, and engages over the securing pivot lever 26. The second rivet head 71.2, which is configured to be semi-circular in cross-section here, engages over the bore wall of the passage hole provided in the lower wall 47. The rivet 61, with its rivet heads 71.1 and 71.2, is produced in such a manner that the distance between the two rivet heads 71.1 and 71.2 is slightly greater than the sum of the amounts of the thickness of the lower wall 47, the thickness of the washer 67, and the thickness of the securing pivot lever 26 in the region of the rivet 61. In this manner, the result is achieved that the rivet 61 is connected with or attached on the lower wall 47 of the transverse connection cap 43 so as to rotate essentially freely or actually freely. In this manner, particularly easy pivotability or rotatability of the securing pivot lever 26 about its pivot axis or axis of rotation 27 can be achieved right from the start, i.e. at all times, so that the securing pivot lever can always be pivoted about its pivot axis 27 manually, without any tool being required for this.

The securing pivot lever 26 preferably consists of cast metal, particularly of zinc die-casting, tempered or steel casting.

The securing pivot lever 26 comprises two lever arms 37.1 and 37.2. The first lever arm 37.1, which functions as a securing arm, extends in a first direction 36.1, proceeding from the pivot axis 27 of the securing pivot lever 26, and the second lever arm 37.2, which functions as an engagement arm, extends in a second direction 36.2, proceeding from the pivot axis 27 of the securing pivot lever 26, specifically, here, opposite the first direction 36.1.

The attachment position of the securing pivot lever 26 on the lower wall 47 and the length of the first lever arm 37.1 of the securing pivot lever 26, which functions as a securing arm, are configured to be coordinated with one another, in such a manner that the securing pivot lever 26 engages underneath the carrier 30, configured as a round scaffold pipe here, in its closed or lift-off protection position 31 (FIGS. 1 to 3), all the way beyond its center axis.

In the region of the free end 39 of the second lever arm 37.2 of the securing pivot lever 26, which functions as an engagement arm, a bore 56 configured as a dead-end hole is provided. In this hole, a pot-like hollow body 52 is attached, here by being pressed in. The inner walls of the hollow body 52, which are cylindrical here, delimit a cavity 53, in which a pressure spring 49 and a pressure piece 50 configured as a ball 51 are accommodated. In this connection, the pressure spring 49 is supported at one end on the bottom of the hollow body 52, while it is supported at the other end on the pressure piece 50 or the ball 51. In order to avoid that the ball 51 and the pressure spring 49 can fall out of the hollow body 52, the latter is configured in cage-like manner. For this purpose, the hollow body 52 has an overlap part 54 that partly overlaps the cavity 53. The overlap part 54 has an opening 68, whose opening diameter 69 is smaller than the outside diameter 70 of the ball 51. In this manner, the ball 51 and also the pressure spring 49 that supports itself on it, on the inside, cannot fall out of the hollow body 52. The pressure spring 49 is configured, with its spring path, coordinated in such a manner that it presses the ball 51 against the overlap part 54, exerting pressure forces 55, so that the ball 51, acted on by the spring force of the spring 59, projects outward beyond the overlap part 54 by a certain dimension, if it is not prevented from this by external restrictions or forces.

The pressure spring 49 and the ball 51 that functions as a pressure piece 50 are part of a spring-elastic detent element 35 or form a spring-elastic detent element 35. This element serves to secure the securing pivot lever 26 both in its closed or lift-off protection position 31 (FIGS. 1 to 3) and in its open position, which is pivoted by about 90 degrees about the pivot axis 27 in comparison, by means of shape-fit but releasable engagement, against unintentional pivoting about its pivot axis 27, in such a manner that pivoting of the securing pivot lever 26 about its pivot axis 27 both from the closed or lift-off protection position 31 into the open position 28 and from the open position 28 into the closed or lift-off protection position 31 is possible only when an increased pivot force is applied. The amount of the pivot force is determined, among other things, by the spring characteristic line of the spring 49, and by the shape of the pressure piece 50, as well as by the shape of the openings or bores or holes 40.1 and 40.2, which here are provided on or in the lower wall 47 of the transverse connection cap 43. In FIG. 6, in particular, it can be seen that in the engagement position shown there, the ball 51, which functions as a pressure piece 50, has engaged into the opening 40. The shape of the opening 40 or of the two openings 40.1 and 40.2 and its/their placement is particularly evident from FIGS. 3 and 4. Each opening 40.1 and 40.2 is configured as an oblong hole 45.1 or 45.2 here. Their longitudinal axes 46.1, 46.2 extend perpendicular, in each instance, to the pivot axis 27 of the securing pivot lever 26, and intersect the pivot axis 27, in each instance. The oblong holes 45.1 and 45.2 are disposed, in each instance, at a distance from the pivot axis 27 and also at a distance from one another, as well as offset from one another by a circumference angle 44, which amounts to about 90 degrees here, relative to the pivot axis 27. In this manner, a securing engagement position 32 can therefore be determined by the opening 40.1, in which the resilient detent element 35, respectively the resiliently mounted ball 51 that functions as a pressure piece 50, can engage or be engaged there with shape fit.

In contrast to this, an open engagement position 29 can be determined by the second opening 40.2 or by the second oblong hole 45.2, whose longitudinal axis 46.2 is disposed approximately perpendicular to the longitudinal axis 46.1 of the first oblong hole 45.1, in which the resilient detent element 35, respectively the resiliently mounted ball 51 that functions as a pressure piece 50, can engage or is engaged in the second opening 40.2, with shape fit, when the securing pivot lever 26 is pivoted or has been pivoted into its open position 28.

The securing pivot lever 26 has a stop body 64 configured in the form of a projections in the region of its first lever arm 37.1 that functions as a securing arm. This body extends perpendicular to the longitudinal axis 34 of the securing pivot lever 26 and parallel to its pivot axis 27. In the assembled state and in the usage position 22 of the platform unit 20, the stop body 64 extends in the vertical direction. In this connection, the stop body 64 projects beyond the underside 77 of the securing pivot lever 26 by a length, in such a manner that in the assembled state of the securing pivot lever 26, it overlaps the front vertical transverse face wall 59 of the transverse connection cap 43, so that the stop body 64 can be brought to make contact there (cf. particularly FIGS. 3 to 5). The stop body 64 itself comprises both a first stop 62.1 and also a second stop 62.2 for the securing pivot lever 26. The first stop 62.1 serves to prevent further pivoting of the securing pivot lever in the first pivot direction 63.1, beyond the closed or lift-off protection position 31, particularly into a further open position, when the securing pivot lever 26 is pivoted about its pivot axis 27 in a first pivot direction 63.1 (FIG. 4) from an or the open position 28 into the closed or lift-off protection position 31, in that in this position, the first stop 62.1 makes contact with the vertical transverse face wall 59 of the transverse connection cap 43.

In contrast to this, the second stop 62.2 serves to prevent further pivoting of the securing pivot lever 26 beyond the open position 28 in the second pivot direction when the securing pivot lever 26 is pivoted about its pivot axis 27 in a second pivot direction 63.2, opposite the first pivot direction 63.1, from the closed or lift-off protection position 31 into an or the open position 28. This is done in that the second stop 62.2 then also makes contact on the vertical transverse face wall 59 of the transverse connection cap 43, but at a different location.

The common stop body 64 is disposed, with its first stop 62.1 and with its second stop 62.2, on the securing pivot lever 26, in such a manner, and the latter is disposed and mounted on the transverse connection cap 43 in such a manner that the securing pivot lever 26 can be pivoted or is able to be pivoted about a pivot angle 65 of maximally about 90 degrees here, about its pivot axis 27. In this manner, the stop body 64 limits the pivot path of the securing pivot lever 26 about its pivot axis 27, with its two stops 62.1 and 62.2, by way of the two engagement positions that are determined by the openings 40.1 and 40.2, i.e. beyond the open engagement position 29 and the securing engagement position 32. In this manner, it is ensured that the securing pivot lever 26 always can be pivoted about its pivot axis 27 only within the limits determined by the two stops 62.1 and 62.2 of the stop body 64 in combination with the vertical transverse face wall 59 of the transverse connection cap 43 and the mounting or attachment of the securing pivot lever 26 itself, and consequently, can exclusively be in an open position 28 or in a closed or lift-off protection position 31, or at most in an intermediate position situated between these two positions. An operator can already see from far away whether the securing pivot lever is in one of its two end positions, i.e. either in its open position 28 or in its closed or lift-off protection position 31, or actually in an intermediate position. Positioning of the securing pivot lever in such an intermediate position can be effectively avoided by means of the following measures: due to the two end engagement positions that can be brought about with the resilient detent element 35, i.e. the open engagement position 29, on the one hand, and the securing engagement position 32, on the other hand, and due to a noise that can be clearly heard by the operator, at the same time, when engagement into these two end engagement positions takes place, an operator can, in the final analysis, ensure that the securing pivot lever is pivoted into one of the two end engagement positions, in any case. In addition to the two end positions, which are clearly different from one another because they are offset by about 90 degrees from one another, i.e. the open position 28, on the one hand, and the closed or lift-off protection position 31, on the other hand, better recognition of the securing position, in each instance, can additionally be ensured by means of suitable contrasting coloring of the securing pivot lever 26, so that it can be seen from far away whether or not the platform units 20, with their securing pivot levers 26, which function as lift-off protections 25, are secured against lift-off.

The securing pivot lever 26 is configured in the shape of a clock hand or an arrow. Its securing arm 37.1 narrows toward its tip or towards its free end 38. The latter is configured rounded off, in order to avoid injury. In the open position 28, in which the securing pivot lever 26 is engaged in its open engagement position 28, the longitudinal axis 38 of the securing pivot lever 26 extends approximately perpendicular to the center longitudinal axis 74 of the platform unit 20.

Furthermore, the securing pivot lever 26 is covered by the horizontal lower wall 47 of the transverse reinforcement cap 43 in its open position 28, seen in a view from above onto the platform unit 20, except for its stop body 64. In other words, seen in a view from above onto the platform unit 20, only the stop body 64 of the securing lever 26 projects beyond the vertical transverse face wall 59 of the transverse connection cap 43 in the open position 28. The securing arm 37.1 of the securing pivot lever 26, in its open position 28, extends away to the outside in a direction approximately perpendicular to the center longitudinal axis 74 of the platform unit 20.

In contrast to this, the securing arm 37.1 of the securing pivot lever 26, in its closed or lift-off protection position 31, in which it is engaged in the securing engagement position 32, which position is pivoted relative to the open position 28 by about 90 degrees, here in the counterclockwise direction, extends approximately parallel to the center longitudinal axis 74 of the platform unit 20, and projects beyond the vertical transverse face wall 59 of the transverse connection cap 43, seen in a view from above onto the platform unit 20.

For the purpose of securing the platform unit 20, one can proceed as follows:

Proceeding from an open position, in which the platform unit 20 can be laid onto the horizontal carrier 30, preferably proceeding from the open position 28, in which the securing pivot lever 26 is engaged in the open engagement position 29 by means of shape-fit engagement of the ball 51, which functions as a pressure piece 50, in the opening 40.2 of the lower wall 47, which is configured as an oblong hole 45.2 (cf. FIG. 4), first the platform unit 20 is laid onto the horizontal carrier, here the scaffold pipe 30 configured as a round pipe, with its suspension hooks 66.1 and 66.2. It is understood that the same can hold true analogously also for the second securing pivot lever provided in the region of the other face end of the platform unit 20, which lever is not shown in the figures, and for the other two suspension hooks that might be provided there, which can be laid onto another horizontal carrier, which can also be a scaffold pipe configured as a round pipe.

Proceeding from this open position 28 or from these open positions, the securing pivot lever 26 is or the securing pivot levers are pivoted, by means of manual and here tool-free pivoting, about its pivot axis or axis of rotation 27, which is vertical in the usage position 22 of the platform unit 20, from the open position into its or their closed or lift-off protection position 31, in which the securing pivot lever(s) 26 is/are also engaged in its or their securing engagement position 32, in which the ball 51, which also functions as a pressure piece 50, engages into or is engaged into the opening 40.1 of the lower wall 47 of the transverse connection cap 43, which opening is configured as an oblong hole 45.1, with shape fit, acted on by the pressure spring 49. In this securing engagement position 32, the securing pivot lever 26 can be pivoted back from its closed or lift-off protection position 31 into an open position or into the open position 28, in the direction of the arrow 63.2 shown in FIG. 3, only when an increased pivot force is applied. Pivoting of the securing pivot lever 26 from its closed or lift-off protection position 31 into the opposite direction 63.1 is not possible, due to the stop 62.1 formed by the stop body 64, or is at most possible only slightly, within the narrow limits determined by it.

Releasing the platform unit 20 that has been secured against lift-off from the horizontal carrier(s) 30 using the securing pivot lever 26 the the securing pivot levers, is described below:

Proceeding from the closed or lift-off protection position(s) 31 of the securing pivot lever(s) 26, in which the platform unit 20 against lift-off from the carrier 30, with the formation of the shape-fit engagement brought about by means of the spring-elastic detent element 35, here by means of engagement of the ball 51, which is acted on by the pressure spring 49 and functions as a pressure piece 50, in the opening 40.1 in the lower wall 47 of the transverse connection cap 43, which opening is configured as an oblong hole 45.1, the securing pivot lever(s) 26 is/are pivoted manually, and here, without any tools, with the application of an increased pivot force, for example in the direction of the arrow 63.2 shown in FIG. 3, from the closed or lift-off protection position 31 into an open position. In the course of this, unlocking of the spring-elastic detent element 35 takes place here, in such a manner that the ball 51 is pressed back, counter to the spring force of the pressure spring 49, into the cavity 53 of the hollow body 52, specifically all the way into a position as shown in FIG. 7, for example. In this position, the ball 51 lies lies against the surface of the lower wall 47 of the transverse connection cap 43, under pressure, acted on by the spring force of the pressure spring 49. In the course of further pivoting of the securing pivot lever 26, further in the direction of the arrow 63.2, the ball 51 slides approximately on an arc about the pivot axis 27 of the securing pivot lever 26. For the purpose of releasing the platform unit 20, the securing pivot lever 26 is pivoted further in the pivot direction 63.2, until an open position has been reached, in which the platform unit 20 can be lifted off from the carrier 30, in each instance. Preferably, the securing pivot lever 26, proceeding from its closed or lift-off protection position 31, is pivoted further in the pivot direction 63.2, about its pivot axis 27, until shape-fit engagement by means of the spring-elastic detent element 35, in the open position 28, is achieved, in which the ball 51, acted on by the spring force of the pressure spring 49, therefore engages into or has engaged into the second opening 40.2 in the lower wall 47 of the transverse connection cap 43, which opening is configured as an oblong hole 45.2, with shape fit. Then no problems or collisions due to the securing pivot lever 26, in each instance, can occur during lift-off of the platform unit 20 from the carrier 30, in each instance, or during repeated laying down of the platform unit 20 onto the carrier 30, in each instance, because this lever has been pivoted essentially completely, i.e. here with the exception of its stop body 64, in each instance, underneath the lower wall 47, in other words does not project beyond the lower wall 47 or the transverse face wall 49 of the transverse connection cap 43 in a direction in which the suspension hooks 66.1, 66.2, in each instance, extend away toward the outside from this transverse face wall 59.

### REFERENCE SYMBOL LIST

20 platform unit/scaffold floor/catwalk
21 face end region of 20
22 usage position of 20
23 longitudinal edge bar
23.1 longitudinal edge bar
23.2 longitudinal edge bar
24 tab
24.1 tab
24.2 tab
25 lift-off protection
26 securing pivot lever
27 pivot axis/axis of rotation of 26
28 open position
29 open engagement position/first engagement position
30 carrier/transverse cross-bar/scaffold pipe/round pipe
31 closed or lift-off protection position
32 securing engagement position/second engagement position
33 local joining locations or connection structures
34 longitudinal axis of 26
35 detent element
36.1 first direction
37.1 first lever arm/securing arm
36.2 second direction
37.2 second lever arm/engagement arm
38 free end of 37.1
39 free end of 37.2
40 opening/bore/hole
40.1 first opening/bore/hole
40.2 second opening/bore/hole
41 part
42 face end profile/transverse reinforcement profile
43 transverse cap/transverse connection cap
44 circumference angle
45 oblong hole
45.1 oblong hole
45.2 oblong hole
46 longitudinal axis of 45
46.1 longitudinal axis of 45.1
46.2 longitudinal axis of 45.2
47 lower wall of 43
48 floor profile part
49 spring/pressure spring
50 pressure piece
51 ball
52 hollow body
53 cavity
54 overlap part
55 pressure force
56 opening/bore/dead-end hole
57 side wall of 23
57.1 side wall of 23.1
57.2 side wall of 23.2
58 catwalk and work surface
59 transverse face wall of 43
60 attachment medium
61 rivet/hollow rivet
62.1 first stop
62.2 second stop
63.1 pivot direction
63.2 pivot direction
64 stop body
65 pivot angle
66 suspension aid/suspension hook
66.1 suspension aid/suspension hook
66.2 suspension aid/suspension hook
67 washer
68 opening/bore/hole
69 inside diameter of 68
70 outside diameter of 51
71.1 first rivet head of 61
71.2 second rivet head of 61
72 bore/dead-end hole
73 elevation/formed-on part
74 longitudinal center axis of 20
75 catwalk sheet metal
76 passage hole
77 underside of 26

1-29. (canceled)

30. Platform unit having at least one lift-off protection (25) attached in a face end region (21) of the platform unit, configured with a securing pivot lever (26) that can be pivoted manually about a pivot axis that is vertical in the usage position (22) of the platform unit, from an open position (28), in which the platform unit (20) can be laid onto or lifted off from a horizontal carrier, into a closed or lift-off protection position (31), and vice versa, in which the platform unit (20), when it is laid onto the carrier (30), is secured against lift-off from the carrier (30), whereby the securing pivot lever (26), at least in its closed or lift-off protection position (31), is secured to prevent unintentional Pivoting about the pivot axis (27), by means of a spring-elastic detent element (35), with the formation of a shape-fit engagement, in a first engagement position (29), and whereby the securing pivot lever (26) has a first lever arm (37.1) that extends away from the pivot axis (27) in a first direction (36.1), transverse, and a second lever arm (37.2) that extends away from the pivot axis (27) in a second direction (36.2), transverse, wherein
the detent element (35), which is configured to be movable relative to the second lever arm (37.2), in the direction of the pivot axis (27), with a pressure piece (50) acted on by means of a spring, and is disposed at a distance from the pivot axis (27), is attached or mounted in or on the second lever arm (37.2), or attached or mounted in or on a part of the platform unit provided in a face end region of the platform unit, and engages resiliently on the second lever arm, and wherein the pressure piece (50) is engaged, with shape fit, in the engagement position (29, 32), acted on by the force of the spring, in an opening of the platform unit (20) disposed at a distance from the pivot axis (27), so that then, pivoting of the securing pivot lever (26) about the pivot axis (27) from the closed or lift-off protection position (31) into the open position (28) is possible only when an increased pivoting force is applied.

31. Platform unit according to claim 30, wherein the securing pivot lever (26) is additionally secured to prevent unintentional pivoting about the pivot axis (27), also in its open position (28), by means of a or the spring-elastic detent element (35), with the formation of a shape-fit engagement, in a second engagement position (32), in such a manner that pivoting of the securing pivot lever (26) about the pivot axis (27), from the open position (28) into the closed or lift-off protection position (31), is only possible when an increased pivot force is applied.

32. Platform unit according to claim 30, wherein the securing pivot lever (26) carries the detent element (35) that is attached or mounted on or in it.

33. Platform unit according to claim 30, wherein the detent element (35) is engaged, with shape fit, in an opening of the platform unit (20), in the engagement position (29, 32), in each instance, or in every engagement position.

34. Platform unit according to claim 30, wherein at least one first opening (40.1) for engagement of the resilient detent element (35) in a or the securing engagement position (32) of the securing pivot lever (26) and at least one second opening (40.2) for engagement of a or of the resilient detent element (35) in a or the open engagement position (29) of the securing pivot lever (26) are provided in a part (41) of the platform unit (20) provided in the face end region (21) of the platform unit (20), whereby the openings (40.1, 40.2) are disposed, in each instance, at a distance from the pivot axis (27) and at a distance from one another, as well as offset relative to the pivot axis (27), by a circumference angle (44), relative to one another.

35. Platform unit according to claim 30, wherein the spring (49) and the pressure piece (50) are accommodated in a cavity (53) of a hollow body (52), which has an overlap part (54) that secures the pressure piece (50) to prevent it from falling out, which part overlaps the cavity (53), whereby the pressure piece (50) lies against the overlap part (54), acted on by the spring force of the spring (49), with the formation of pressure forces (55).

36. Platform unit according to claim 35, wherein the hollow body (52) that contains the spring (49) and the pressure piece (50) is attached in an opening or bore (56).

37. Platform unit according to claim 30, wherein the securing pivot lever (26) has at least one first stop (62.1), which prevents further pivoting of the securing pivot lever (26) when the securing pivot lever (26) is pivoted about its pivot axis (27) in a first pivot direction (63.1), from an or the open position (28) into the closed or lift-off protection position (31), in this first pivot direction (63.1), beyond the closed or lift-off protection position (31), into a further open position

38. Platform unit according to claim 30, wherein the securing pivot lever (26), if applicable in addition, has a second stop (62.2), if applicable, which prevents further pivoting of the securing pivot lever (26) when the securing pivot lever (26) is pivoted about its pivot axis (27) in this second pivot direction (63.2), if applicable, from the closed or lift-off protection position (31) into an or the open position (28), in this second pivot direction (63.2), if applicable.

39. Platform unit according to claim 37, wherein the first stop (62.1) and the second stop (62.2) are part of a common stop body (64) of the securing pivot lever (26).

40. Platform unit according to claim 37, wherein the first stop (62.1) and the second stop (62.2) are disposed on the securing pivot lever (26) in such a manner, and wherein the securing pivot lever (26) is disposed and mounted on a part (41) of the platform unit (20), in such a manner that the securing pivot lever (26) can be pivoted about a pivot angle (65) of maximally 180 degrees about its pivot axis (27).

41. Platform unit according to claim 30, wherein it is laid onto or suspended on at least two horizontal carriers (30) of a scaffold, a podium, a staircase, a stage, or a similar support construction or a similar spatial support structure, and has at least one such securing lever (26), in each instance, on two of its face end regions (21) that extend away from one another, in opposite directions.

42. Method for securing a platform unit (20) against lift-off from a horizontal carrier (30), wherein a platform unit (20) configured according to claim 30 is pivoted, using a lift-off protection (25) formed by a securing pivot lever (26), by means of manual pivoting of the securing pivot lever (26) about a pivot axis that is vertical in the usage position (22) of the platform unit (20), from an open position (28), in which the platform unit (20) can be laid onto the horizontal carrier or lifted off from it, into a closed or lift-off protection position (31) after the platform unit (20) has been laid onto or suspended onto the carrier (30), and also into a securing engagement position (32), in which, during the course of manual pivoting of the securing pivot lever (26) about its pivot axis (27), a spring-elastic detent element (35) brings about shape-fit engagement of the securing pivot lever (26), so that then, the securing pivot lever (26) can be pivoted out of its closed or lift-off protection position (31) into the open position (28) only when an increased pivot force is applied.

43. Method for releasing a platform unit (20) configured according to claim 30, which is secured against lift-off from a horizontal carrier (30), using a lift-off protection (25) formed by a securing pivot lever (26), wherein the securing pivot lever (26), proceeding from a closed or lift-off protection position (31), in which the platform unit (20) is secured against lift-off from the carrier (30), with the formation of a shape-fit engagement, brought about by means of a spring-elastic detent element (35), in a securing engagement position (32), the securing pivot lever (26) is pivoted manually, with the application of an increased pivot force and with simultaneous unlocking of the resilient detent element (35), about a pivot axis that is vertical in the usage position of the platform unit, from the closed or lift-off protection position (31), into an open position (28), in which the platform unit (20) can be lifted off from the carrier (30).

44. Method according to claim 43, wherein during the course of the manual pivoting of the securing pivot lever (26) about its pivot axis (27), from the closed or lift-off protection position (31) into the open position (28), then a spring-elastic detent element (35) or the spring-elastic detent element (35) brings about shape-fit engagement of the securing pivot lever (26) in an open engagement position (29), so that then, the securing pivot lever (26) can be pivoted out of this open position (28) only when an increased pivoting force is applied.
